(19) United States
(12) Patent Application Publication
(10) Pub. No.: US 2002/0012305 A1
(43) Pub. Date: Jan. 31, 2002

(54) Optical recording medium and optical recording method

(75) Inventors: Hiroshi Shingai, Tokyo (JP); Hiroyasu Inoue, Tokyo (JP); Tatsuya Kato, Tokyo (JP); Hajime Utsunomiya, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TDK CORPORATION, Chuo-ku (JP)

(21) Appl. No.: 09/883,199

(22) Filed: Jun. 19, 2001

(30) Foreign Application Priority Data
Jun. 20, 2000 (JP) 2000-185496

(51) Int. Cl. G11B 7/24

(52) U.S. Cl. 369/59.11; 369/275.4

(57) ABSTRACT

In an optical recording medium having a phase change recording layer, recorded marks having a shortest length of up to 350 nm are formed in the recording layer which contains Sb as a main component. This enables formation of microscopic recorded marks which are stabilized in shape and size. The medium remains reliable in that the microscopic recorded marks are improved in thermal stability.

This invention relates to a phase change optical recording medium in which microscopic recorded marks are formed and a method for recording information in the medium.

### BACKGROUND OF THE INVENTION

Great attention is now paid to optical recording media capable of high density recording and erasing the once recorded information for rewriting. Among such rewritable optical recording media, phase change recording media are designed such that recording is performed by irradiating a laser beam to a recording layer to change its crystalline state and reading is performed by detecting the change of reflectivity of the recording layer associated with that state change. The phase change recording media are of greater interest because overwriting is enabled by modulating the intensity of a single laser beam and the drive unit used for their operation may have a simple optical system as compared with that used for magneto-optical recording media.

For the phase change recording layer, calcogenide materials such as Ge—Te and Ge—Sb—Te are often used because of a greater difference in reflectivity between crystalline and amorphous states and a relatively high stability in the amorphous state. Additionally, it was recently proposed to apply compounds known as chalcopyrite to the phase change recording layer. The chalcopyrite compounds have been widely studied as compound semiconductor material and applied to solar batteries and the like. The chalcopyrite compounds have a composition represented by Ib-IIIb-VIb₂ or IIb-IVb-Vb₂ according to the notation of the Periodic Table and are configured to have two stacked diamond structures. The structure of chalcopyrite compounds can be readily determined by x-ray structural analysis. Their fundamental characteristics are described, for example, in Monthly Physics, vol. 8, No. 8, 1987, p. 441 and Electrochemistry, vol. 56, No. 4, 1988, p. 228. Of these chalcopyrite compounds, it is known that AgInTe₂ can be used, after dilution with Sb or Bi, as the recording layer material in optical recording media adapted for operation at a linear velocity of about 7 m/s. JP-A 3-240590, 3-99884, 3-82593, 3-73384 and 4-151286 disclose phase change optical recording media using such chalcopyrite compounds. Besides, JP-A 4-267192, 4-232779 and 6-166268 disclose phase change optical recording media wherein an AgSbTe₂ phase is created when the recording layer crystallizes.

In general, information is recorded in phase change optical recording media by first conditioning the entire recording layer to be crystalline and irradiating a laser beam of a sufficient high power (recording power) to heat the recording layer at or above its melting point. At every spot where the recording power is applied, the recording layer is melted and then quenched, forming an amorphous recorded mark. The recorded mark can be erased by irradiating a laser beam of a relatively low power (erasing power) so that the recording layer is heated to a temperature from its crystallization temperature to lower than its melting point. At the recorded mark where the erasing power is applied, the material is heated at or above the crystallization temperature and then slowly cooled, resuming crystallinity. Consequently, the phase change optical recording medium enables overwriting by modulating the intensity of a single light beam.

As compared with magnetic recording media, phase change optical recording media and other optical recording media generally have a high recording density. The recent need to process a vast quantity of information as in images requires to further increase the recording density for increasing the recording capacity per medium and to increase the data transfer rate. For increasing the recording density per unit area, it is effective to reduce the length of recorded marks.

We conducted an experiment of forming recorded marks of different sizes in a recording layer of a Ge—Sb—Te material customarily used as the phase change material. The recorded marks were observed under a transmission electron microscope. It was found that coarse crystal grains were created in proximity to the trailing edge of a recorded mark to cause substantial distortion of the recorded mark and shift the position of the recorded mark trailing edge. The pattern of coarse crystal grain creation is random so that the distortion pattern and the positional shift of the trailing edge differ among recorded marks. This renders useless the countermeasure of effecting correction whenever recorded marks are read out. If the variation in shape or size of recorded marks is large relative to the length of recorded marks, a significant increase of jitter occurs.

From the results of the above experiment, we have found that the variation in shape or size of recorded marks induced by coarse crystal grains created in the Ge—Sb—Te base recording layer induces a critical increase of jitter when the recorded mark length is made shorter than a specific value, illustratively shorter than 350 nm, preferably shorter than 300 nm, and especially shorter than 250 nm (all inclusive).

We have also found that if the recorded mark length is at or below the specific value, the recorded marks formed in the phase change recording layer become critically low in thermal stability so that the recorded marks are prone to crystallize during storage in a hot environment, resulting in a loss of reliability.

For improving the transfer rate, not only reducing the length of recorded marks, but increasing the linear velocity is also effective. Independent of whether the transfer rate is improved by reducing the length of recorded marks or by increasing the linear velocity, the composition of the recording layer must have a relatively high crystal transition speed so that amorphous recorded marks can be erased or recrystallized within a relatively short time. The recording layer having a high crystal transition speed, however, readily crystallizes in a relatively hot environment, giving rise to the problem of low storage reliability.

### SUMMARY OF THE INVENTION

Therefore, an object of the invention is to provide a phase change optical recording medium capable of forming microscopic recorded marks which are stabilized in shape and size. Another object of the invention is to provide a phase change optical recording medium which remains reliable in that microscopic recorded marks are stabilized in shape and size and improved in thermal stability.

In one aspect of the invention, there is provided an optical recording medium having a phase change recording layer containing antimony as a main component, in which recorded marks having a shortest length of up to 350 nm are formed.

In a preferred embodiment, the recording layer further contains tellurium or indium or both as a main component, and further preferably contains at least one element selected from among germanium, nitrogen and rare earth elements as an auxiliary component.

In another aspect of the invention, there is provided an optical recording method comprising the step of irradiating recording beam which has been power modulated between a high power and a low power, to the optical recording medium for thereby forming amorphous recorded marks in the recording layer. The recorded marks include shortest recorded marks having a leading edge and a trailing edge, at least a part of the trailing edge being convex toward the leading edge.

In a preferred embodiment, the convex shape at the trailing edge of the shortest recorded marks is formed by causing the regions melted by irradiation of recording beam to crystallize. Further preferably, the shortest recorded marks are formed so as to meet the relationship:

M_{L}≦0.4λ/NA

wherein the shortest recorded marks have a length M_{L}, the recording beam has a wavelength λ, and an objective lens of a recording optical system by which the recording beam is transmitted has a numerical aperture NA. Also preferably, the shortest recorded marks are formed so as to meet the relationship:

M_{W}/M_{L}>1

wherein the shortest recorded marks have a width M_{W} and a length M_{L}.

### BRIEF DESCRIPTION OF THE DRAWINGS

FIG. 1 schematically illustrates a recorded mark.

FIG. 2 is a diagram illustrating one exemplary recording pulse strategy.

FIG. 3 is a fragmentary cross-sectional view of one exemplary optical recording medium.

FIG. 4 is a fragmentary cross-sectional view of another exemplary optical recording medium.

### DESCRIPTION OF THE PREFERRED EMBODIMENTS

We carried out the following experiment. First, a phase change recording layer of Ge₂Sb₂Te₅ was formed by sputtering. Recorded marks having a length of 250 nm were formed in this medium. It is noted that the recorded mark length is calculated from the linear velocity of the medium and the frequency of recording beam. Photomicrographs of the recorded marks were taken under a transmission electron microscope (TEM). In the photomicrographs, coarse crystal grains having a diameter approximate to one half of the recorded mark length were found near the trailing edge of each recorded mark. The size and number of coarse crystal grains differed among recorded marks, and the recorded mark length varied among them. Since the coarse crystal grains causing the variation of the recorded mark length have a diameter ranging from several ten nanometers to about one hundred nanometers, they have a substantial influence on recorded marks of 250 nm length.

Separately, recorded marks having a length of 250 nm were formed in a recording layer of the composition prescribed by the invention, that is, a recording layer containing Sb, Te and Tb. TEM photomicrographs of the recorded marks were taken. In these photomicrographs, coarse crystal grains of a large size enough to distort the shape of recorded marks were not found. More particularly, in these photomicrographs, coarse crystal grains existed near the trailing edge of recorded marks, but had little influence on the trailing edge shape of recorded marks. The variation of the recorded mark length is minimized.

Since coarse crystal grains created in proximity to the trailing edge of a recorded mark have little influence on the shape and size of the recorded mark, the recording layer used herein ensures correct reproduction with a minimal jitter.

According to the invention, in order to improve the thermal stability of microscopic recorded marks, at least one of Ge, N and rare earth elements is contained as an auxiliary component in the recording layer containing Sb as a main component. The addition of the auxiliary component serves to elevate the crystallization temperature of the recording layer, establishing higher reliability.

The invention is effectively applied to phase change optical recording media adapted to form microscopic recorded marks having a shortest length equal to or below the above-specified value, that is, up to 350 nm, preferably up to 300 nm, and especially up to 250 nm. For the optical recording media to which the invention is applied, it is not critical how to form recorded marks and how to read them out.

It is unknown in the prior art that when microscopic recorded marks are formed in Ge—Sb—Te base recording layers, the shape and size of recorded marks are substantially affected by coarse crystal grains. Although phase change recording layers based on Sb and Te are well known in the art, it is unknown that when microscopic recorded marks are formed in the recording layers based on Sb and Te, the shape and size of recorded marks have little variances.

It is unknown in the prior art that the thermal stability of the recording layer-forming material becomes very important when microscopic recorded marks having a length below the above-specified value are formed. It is also unknown that the thermal stability of microscopic recorded marks is outstandingly improved by adding at least one of Ge, N and rare earth elements to the recording layer containing Sb as a main component.

FIG. 1 is a schematic diagram of a recorded mark having a leading edge (left side) and a trailing edge (right side). According to the invention, the recorded mark is preferably configured such that at least a part of the trailing edge of the recorded mark is convex toward the leading edge as illustrated in FIG. 1. It is not required that all recorded marks have such a shape. It is only required that at least shortest recorded marks have such a shape.

By configuring the recorded mark to the illustrated shape, the shortest recorded mark can be such that its width M_{W} is greater than its length M_{L} (i.e., M_{W}>M_{L}). The preferred relationship is M_{W}/M_{L}≧1.1. Since read signals are obtained from the phase change optical recording medium by utilizing the difference in reflectivity between the amorphous recorded marks and the remaining crystalline region, the read output from recorded marks of the same length becomes higher as their width increases. Therefore, even when the shortest recorded marks are set shorter in order to increase the linear recording density, the invention ensures sufficient read outputs. However, if M_{W}/M_{L} is too large, there is an increased likelihood of cross-erasing that recorded marks in adjacent tracks are erased and cross-talk that recorded marks in adjacent tracks are read out. For this reason, M_{W}/M_{L} is preferably up to 4, and more preferably up to 3.

Now the method utilized to configure the trailing edge of recorded marks to the desired shape is described together with the reason why the setting: M_{W}>M_{L} can be established using this method.

In recording of a phase change recording medium, at least a laser beam which has been power modulated between the recording power and the erasing power is irradiated as previously mentioned. The recording layer is melted upon irradiation of a laser beam of the recording power, and after the irradiating time corresponding to the recorded mark length has passed, the power of the laser beam lowers to the erasing power whereby the once melted region is quickly cooled to become amorphous. If the molten region is partially crystallized during this recorded mark-forming process without converting its entirety to the amorphous state, then the trailing edge of the recorded mark can be configured to the desired shape. More illustratively, if the cooling rate is slowed down on the trailing edge side of the molten region (where the laser beam moves away), then the trailing edge side is crystallized as illustrated in FIG. 1. In the recorded mark thus formed, it scarcely occurs that the trailing edge in its entirety is convex toward the leading edge, and the most likely shape of the trailing edge is as shown in FIG. 1. More particularly, the recorded mark assumes a shape having a tail protruding in the recording track direction near the center of the trailing edge, say, the shape of bat wings.

It is described in JP-A 9-7176 that the molten region partially crystallizes during formation of recorded marks. Based on the finding that recrystallization occurs in a forward portion of a recorded mark when the optical recording disk is rotated at a low linear velocity, this patent publication proposes to irradiate laser beam of the recording power level in a predetermined pulse pattern in order to prevent the recrystallization. It is described therein that the heat induced in the zone corresponding to the mark aft portion by laser beam irradiation is transferred to the zone corresponding to the once melted mark forward portion and as a result, the mark forward portion is so slowly cooled that recrystallization occurs. The recrystallization based on the mechanism described in JP-A 9-7176 is referred to as “self-erasing” in JP-A 11-232697.

As taught in the above-referenced patent publications, it is known that during recorded mark formation, the trailing portion of a molten region is crystallized by the so-called self-erasing and that this crystallization affects the shape of the recorded mark leading portion. However, it was important in the prior art to eliminate the influence of self-erasing on the recorded mark shape, as described in JP-A 9-7176.

As opposed to the prior teachings, the present invention positively utilizes the same effect as the self-erasing on the trailing edge side of a molten region in such a way that the trailing edge side of the molten region is crystallized to configure the recorded mark trailing edge to the shape illustrated in FIG. 1. In order that the self-erasing function work on the trailing edge side of a molten region, it suffices, for example, to control the power and irradiating time of a laser beam irradiated to the trailing edge side of the molten region. Since the heat induced by the laser beam irradiated to the trailing edge side of the molten region is transferred to the trailing edge side within the molten region, the cooling rate at the molten region trailing portion can be adjusted by controlling the power and time of irradiating laser beam, and as a consequence, the length of the crystallized zone at the molten region trailing edge can be controlled. When the self-erasing function works on the molten region trailing edge side, crystallization takes place mainly in the longitudinal direction of the recorded mark, but little in the transverse direction of the recorded mark. Accordingly, by setting the recording power at a relatively high level, a molten region which is relatively wide and relatively long corresponding to that width is formed. Thereafter, the molten region trailing portion is crystallized by self-erasing, to thereby form an amorphous recorded mark of predetermined length. The recorded mark thus formed has a greater width than a length.

Next, a method for controlling the self-erasing effect on the molten region trailing edge side is described.

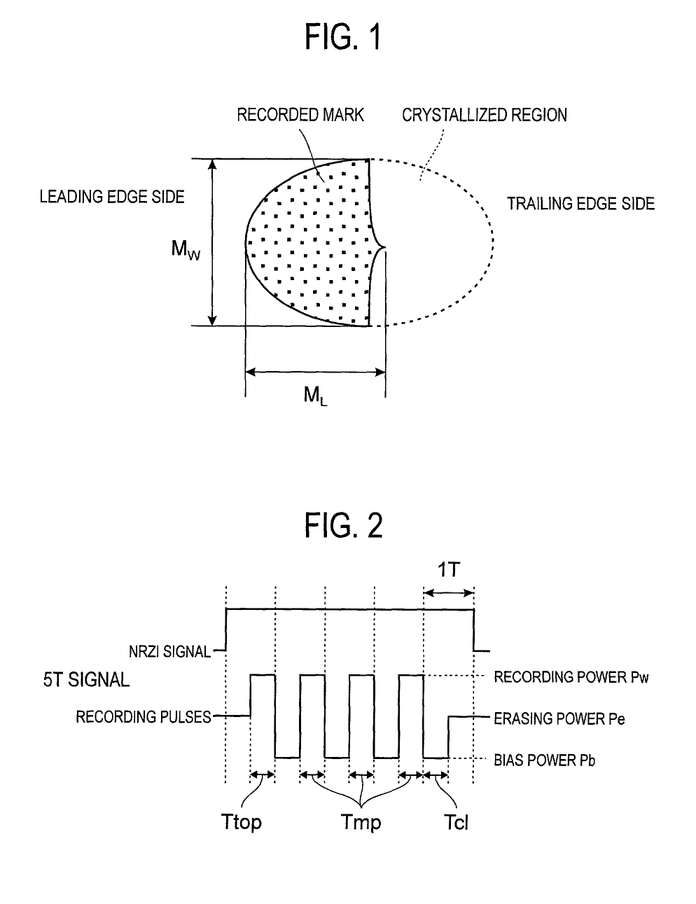

First, the recording pulse strategy is described. In general, information is recorded in a phase change optical recording medium, often by applying the recording power which is divided into a train of plural pulses for the purpose of controlling the shape of a recorded mark as described in the above-referenced JP-A 9-7196, rather than continuously applying the recording power for a duration corresponding to the length of a recorded mark. The construction of pulse division is generally referred to as “recording pulse strategy.” One exemplary recording pulse strategy is shown in FIG. 2. FIG. 2 illustrates a recording pulse train corresponding to 5T signals in NRZI signals. In the figure, Ttop is the width of the leading pulse, Tmp is the width of pulses other than the leading pulse, also referred to as multi-pulses, and Tcl is the width of the downward pulse following the trailing pulse, also referred to as cooling pulse. These pulse widths are generally expressed by values standardized on a reference crock width (1T). In the recording pulse strategy illustrated herein, the power (bias power Pb) of all downward pulses including the cooling pulse is set lower than the erasing power Pe.

When the power modulation of a laser beam is carried out according to the recording pulse strategy illustrated above, the self-erasing effect on the molten region trailing edge side may be regulated by controlling at least one of the recording power Pw, Tmp, the power of the cooling pulse (bias power Pb in the figure), Tcl, and the erasing power Pe. More specifically, a choice may be made among them in accordance with a factor associated with crystallization of the molten region such as the composition of the recording layer or the structure of the medium. Usually, at least one of the recording power Pw, erasing power Pe and Tcl is preferably controlled.

Now that the recorded mark length is controlled by the self-erasing effect in this way, the design of recorded mark width is given a high degree of freedom. For example, by setting high both the recording power and the power following recording power irradiation (cooling pulse power and/or erasing power), that is, by inducing a large area of melting and increasing the crystallization area in the molten region trailing portion, recorded marks of large width can be formed to the predetermined length. On the other hand, by setting low both the recording power and the power following recording power irradiation, that is, by inducing a small area of melting and reducing the crystallization area in the molten region trailing portion, recorded marks of small width can be formed to the predetermined length. Accordingly, when only one of guide channels(grooves) and lands between guide channels are used as recording tracks, recorded marks having a sufficiently large width to extend beyond the recording track can be formed. Also, when applied to the land/groove recording mode in which both grooves and lands are used as recording tracks, recorded marks having a large width, but not to extend beyond the recording track can be formed. In either case, high read outputs are available.

Where the self-erasing effect is utilized in this way, it becomes possible that even when the recording power is altered, the recorded mark length be left unchanged if the power following recording power irradiation is altered at the same time. Differently stated, the utilization of the self-erasing effect expands the width of recording power (recording power margin) that can be selected in forming recorded marks of the predetermined length.

By contrast, where the self-erasing effect is not utilized in forming the recorded mark trailing edge, the recorded mark trailing edge is configured to a round shape like the leading edge, as shown in FIG. 2 of the above-referenced JP-A 9-7176. If the recorded marks are shortened in this situation, the width of recorded marks is also reduced in unison with the reduction of the recorded mark length, resulting in recorded marks of a too small area to produce an acceptable output. Also where the self-erasing effect is not utilized, the recorded mark length is determined substantially solely by the recording power, so that the recording power margin is narrowed.

Further, where the self-erasing effect is utilized in forming the recorded mark trailing edge, the jitter is reduced as compared with the case where recorded marks are formed to a circular or oval shape. This becomes more outstanding when shortest recorded marks are formed. Even in a situation where recorded marks have a precise length and a fully large width, if the recording marks are circular or oval, the jitter becomes increased as compared with the case where the self-erasing effect in the molten region trailing portion is utilized. It is generally believed that the jitter becomes smaller as the outline of recorded marks has a more symmetric shape free of asperities. We first discovered that the jitter can be reduced by configuring recorded marks to a shape of low symmetry.

The utilization of the self-erasing effect makes it possible to increase the width of recorded marks relative to their length, and to thereby restrain a drop of read output due to the reduction of recorded mark length. Then the recording relying on the self-erasing effect is effective especially when the length of shortest recorded marks must be reduced. More particularly, this recording is effective especially when shortest recorded marks are formed so as to meet the relationship:

M_{L}≦0.4λ/NA

wherein the shortest recorded marks have a length M_{L}, the recording beam has a wavelength λ, and an objective lens of a recording optical system by which the recording beam is transmitted has a numerical aperture NA. When microscopic recorded marks are formed without utilizing the self-erasing effect at the molten region trailing edge, the recorded marks approach to a circular shape so that the width and length of recorded marks are reduced to approximately equal dimensions, resulting in reduced read outputs. It was found that read outputs from recorded marks having a length M_{L}≦0.4λ/NA become critically short. In contrast, the recording method utilizing the self-erasing effect allows the width of recorded marks to be greater than the length thereof, and hence, recorded marks to have a sufficient width even in the case of M_{L}≦0.4λ/NA. As a result, acceptable read outputs are produced.

The coarse crystal grains existing in proximity to the recorded mark trailing edge are formed by crystallization at the molten region trailing edge. According to the invention, the recorded mark length has a minimized variation, probably because in the Sb-based recording layer, crystallization takes place in accordance with the cooling rate distribution in the molten region trailing portion and stops at the point where the cooling rate reaches the critical value of crystallization. On the other hand, the length of recorded marks in the Ge₂Sb₂Te₅ recording layer has a noticeable variation, probably because once crystallization starts in a low cooling rate region of the Ge₂Sb₂Te₅ recording layer, the crystallization can proceed beyond the point where the cooling rate reaches the critical value of crystallization or stop short of that point.

It is understood that the optical recording medium of the invention is applicable to a recording method other than the recording method utilizing the self-erasing effect in proximity to the molten region trailing edge. Differently stated, the advantages resulting from use of the Sb-based recording layer are obtained in all recording methods involving controlling the length of recorded marks by causing a portion of the molten region to crystallize.

Meanwhile, the advantage of improving the thermal stability of microscopic recorded marks is obtained even when the self-erasing effect is not utilized.

The phase change recording layer that the inventive optical recording medium possesses contains antimony (Sb) as a main component, and preferably at least one element selected from among germanium (Ge), nitrogen (N) and rare earth elements as an auxiliary component. Since the sole use of Sb as the main component can entail a drop of crystallization temperature and hence, a lowering of thermal stability, it is preferred to add tellurium (Te) and/or indium (In) to Sb. Of these, Te is especially preferred because it enables a higher degree of modulation.

When the atomic ratio of elements to constitute the main component is represented by formula I:

SbₐTe_{b}In_{c} I

wherein a+b+c=1, the preferred range is:

a=0.3 to 0.9,

b=0 to 0.7, and

c=0 to 0.7;

the more preferred range is:

a=0.4 to 0.9,

b=0 to 0.6, and

c=0 to 0.6;

and the even more preferred range is:

a=0.5 to 0.9,

b=0 to 0.5, and

c=0 to 0.5.

In formula I, too small a value of “a” representative of the Sb content may entail an increase in the reflectivity difference associated with phase change, but a sharp decline of crystal transition speed to impede erasion. Too large a value of “a” may entail a drop of crystallization temperature which degrades the thermal stability of recorded marks, and also a reduction in the reflectivity difference associated with phase change, resulting in a reduced degree of modulation.

The auxiliary component contained in the recording layer is mainly effective for improving the thermal stability of amorphous recorded marks.

The content of Ge in the recording layer is preferably up to 25 atom %, and more preferably up to 15 atom %. Too high a Ge content may somewhat prevent the phase change type Sb-based recording material from exerting its own characteristics. Since the addition of Ge lowers the crystal transition speed, too high a Ge content may make it difficult to achieve a high transfer rate. In order that Ge accomplish the intended thermal stability enhancement, the Ge content is preferably at least 1 atom %, and more preferably at least 2 atom %.

In order that nitrogen be contained in the recording layer, the recording layer may be formed, for example, by sputtering in an atmosphere containing nitrogen gas in addition to a rare gas such as argon. The flow ratio of nitrogen gas to rare gas in the atmosphere may be set at any desired value as long as the nitrogen addition effect is fully exerted and the nitrogen content does not become excessive. The preferred flow ratio of nitrogen to inert gas is from 2/150 to 8/150. If the flow ratio is too low, the nitrogen content in the recording layer becomes too low, so that the nitrogen addition effect may not be fully exerted. If the flow rate ratio is too high, the nitrogen content in the recording layer becomes too high, so that the reflectance difference of the recording layer associated with a phase change may become smaller, resulting in reduced modulation.

The “rare earth elements” used herein include yttrium (Y), scandium (Sc) and lanthanoids. The rare earth elements do not lower the crystal transition speed unlike Ge and are effective for increasing the crystal transition speed like Sb. Accordingly, by substituting a rare earth element for a part of Sb, the thermal stability of microscopic recorded marks can be improved while maintaining or improving the crystal transition speed thereof. The content of rare earth element in the recording layer is preferably up to 30 atom %, and more preferably up to 25 atom %. Too high a rare earth content may lead to too high a crystallization temperature, which hinders to initialize or crystallize an amorphous recording layer immediately after its formation. In order that the rare earth element added fully exert the effects of increasing the crystal transition speed and the recorded marks' thermal stability, the content of rare earth element should preferably be set at 1 atom % or above, more preferably 2 atom % or above.

In addition to the above-mentioned main and auxiliary components, the recording layer may contain one or more other element if desired. Such an additive element is designated element M wherein M is at least one element selected from among Au, Bi, Al, P, H, Si, C, V, W, Ta, Zn, Ti, Sn, Pb and Ag. Element M is effective for improving durability against rewriting, more specifically for suppressing any loss of erasability by repetitive rewriting. Among the elements M, more effective V and/or Ta is preferred. The content of element M in the recording layer should preferably be 10 atom % or less. Too high an element M content may lead to a small change of reflectivity associated with phase change, failing to provide a degree of modulation.

It is noted that phase change recording layers containing Sb, Te and In as well as Ag are known. For the purpose of increasing the degree of modulation, it is recommended in the present invention to add Te and/or In, especially Te, rather than adding Ag. For the same reason, the addition of element M should preferably be avoided.

Preferably the recording layer has a thickness of 4 to 50 nm, more preferably 4 to 30 nm. Too thin a recording layer may impede the growth of a crystal phase, resulting in an insufficient change of reflectivity associated with phase change. A too thick recording layer possesses a large heat capacity which may retard recording, and has a low reflectivity and a low degree of modulation.

The composition of the recording layer can be analyzed by electron probe microanalysis (EPMA), x-ray microanalysis and inductively coupled plasma emission spectroscopy (ICP), for example.

The recording layer is preferably formed by a sputtering process. The sputtering conditions are not critical. When a material containing plural elements is to be deposited by sputtering, an alloy target may be used. A multi-source sputtering process using a plurality of targets is also useful.

As long as the composition of the recording layer and the size of recorded marks are satisfied, other factors of the recording layer are not critical. The optical recording medium may have any desired structure as long as it satisfies the requirements of the invention.

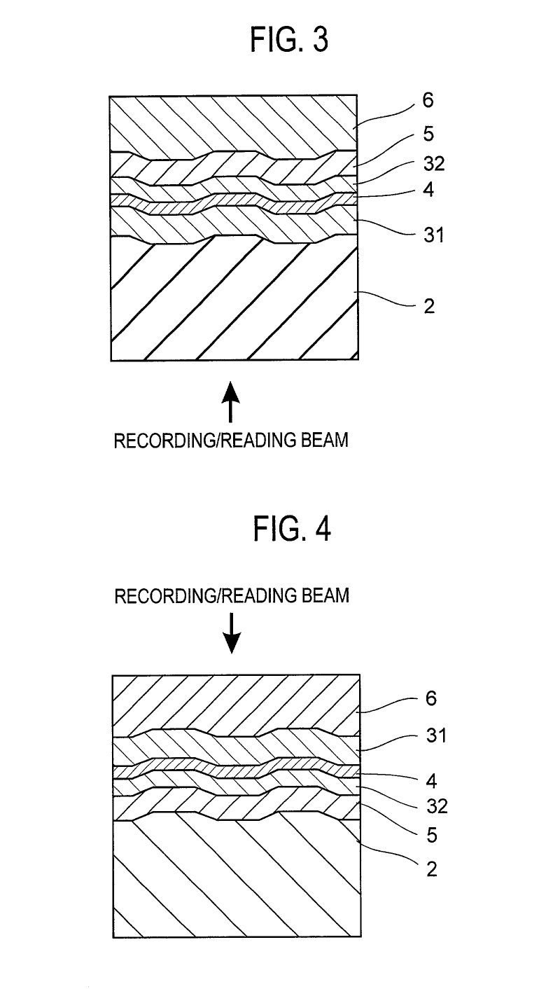

One general construction of the phase change optical recording medium is illustrated in FIG. 3 as comprising a substrate 2, and a first dielectric layer 31, a recording layer 4, a second dielectric layer 32, a reflective layer 5, and a protective layer 6 stacked successively on the substrate 2 in the described order. In this medium, recording/reading beam is irradiated to the recording layer 4 through the substrate 2.

Also, the optical recording medium may be constructed as shown in FIG. 4, such that recording/reading beam is irradiated to the recording layer without passing through the substrate 2. In this embodiment, a reflective layer 5, a second dielectric layer 32, a recording layer 4, and a first dielectric layer 31 are stacked on a substrate 2 in the described order, and a protective layer 6 of a light-transmitting material such as resin is finally laid thereon. Recording/reading beam is irradiated to the recording layer 4 through the protective layer 6.

### EXAMPLE

### Example 1

Samples for measurement were prepared by using slide glass as the substrate and successively forming on its surface a reflective layer, a second dielectric layer, a recording layer and a first dielectric layer.

The reflective layer was formed by sputtering in an argon atmosphere. The target used was Ag₉₈Pd₁Cu₁ (atomic ratio). The reflective layer was 100 nm thick.

The second dielectric layer was formed by sputtering a target of Al₂O₃ in an argon atmosphere. The second dielectric layer was 20 nm thick.

The recording layer contained main and auxiliary components in the combination shown in Table 1. Recording layers containing Tb or Ge were formed by a binary sputtering process using a Sb—Te alloy target and a Tb or Ge target in an argon atmosphere. Recording layers containing nitrogen were formed by sputtering a Sb—Te alloy target in an atmosphere of Ar+N₂. The atomic ratio of elements in the main component was Sb:Te=7:3. The recording layer was 12 nm thick. The Ge or Tb content of the recording layer is shown in Table 1. The flow ratio of N₂/Ar in the gas atmosphere during formation of the recording layer is also shown in Table 1.

The first dielectric layer was formed by sputtering a 80 mol % ZnS-20 mol % SiO₂ target in an argon atmosphere. It was 125 nm thick.

Test

Each sample was rested on a heating stage. While the sample was heated at 30° C./min, light is irradiated to the recording layer through the substrate. The temperature at which the reflectivity changed was determined and reported as the crystallization temperature of the recording layer. The results are shown in Table 1.

TABLE 1

| | | | Ge or Tb | | Crystallization |
|---|---|---|---|---|---|
| Sample | Components | | content | | temperature |
| No. | Main | Auxiliary | (atom %) | N₂/Ar | (° C.) |
| 1 | Sb-Te | — | — | — | 163 |
| 2 | Sb-Te | Ge | 2 | — | 172.5 |
| 3 | Sb-Te | Ge | 5 | — | 188.5 |
| 4 | Sb-Te | Ge | 10 | — | 218.5 |
| 5 | Sb-Te | Tb | 2.4 | — | 184 |
| 6 | Sb-Te | Tb | 4.0 | — | 230 |
| 7 | Sb-Te | N | — | 5/150 | 181 |
| 8 | Sb-Te | N | — | 10/150 | 194.5 |

It is evident from Table 1 that Ge, Tb or N added as the auxiliary component serves to elevate the crystallization temperature for thereby improving thermal stability.

### Example 2

Optical recording disk sample Nos. 1 to 8 were prepared by injection molding polycarbonate into a disk-shaped substrate having a diameter of 120 mm and a thickness of 1.2 mm in which grooves were formed simultaneous with injection molding. On the surface of the substrate, a reflective layer, a second dielectric layer, a recording layer, and a first dielectric layer were successively formed by the same procedure as used in Example 1 for the preparation of test samples.

The recording layers of the disk samples were initialized or crystallized by means of a bulk eraser. Each disk sample was mounted on an optical recording medium tester where overwriting was carried out under the following conditions.

laser wavelength: 405 nm

numerical aperture NA: 0.85

linear velocity: adjusted optimum for each sample

recording signals: single signals having a frequency corresponding to a recorded mark length 173 nm

The recording pulse strategy conformed to the pattern illustrated in FIG. 2.

Ttop:Tmp:Tcl=0.34:0.34:0

number of multi-pulses: 0

Pw=5.0 mW

Pe=1.5 mW

Pb=0.1 mW

Thereafter, the samples were stored for 100 hours in an environment of 80° C. and RH 80%.

The average reflectivity of recorded mark-bearing tracks was measured before and after the storage, from which a change was determined. If the recorded marks crystallize during storage in a hot environment, the average reflectivity changes from the initial. For similar samples in which single signals corresponding to a recorded mark length of 700 nm were recorded for comparison purposes, the reflectivity was similarly measured. It is noted that in the case of recorded mark length 700 nm, the reflectivity of recorded marks was measured rather than the average reflectivity of tracks. In the case of recorded mark length 700 nm, no change of reflectivity was ascertained in all the samples. In the case of recorded mark length 173 nm, the average reflectivity changed in only sample No. 1 having the auxiliary component-free recording layer.

For additional similar samples in which signals corresponding to a recorded mark length of 150 nm were recorded, the average reflectivity was similarly measured before and after storage in a 80° C./RH 80% environment. Sample No. 1 showed a change of average reflectivity after 50 hours of storage. In the other samples, the average reflectivity remained unchanged even after 100 hours of storage.

### Example 3

For sample Nos. 1 to 6 prepared in Example 2, overwriting was repeated 10 cycles, forming recorded marks having a length of 700 nm. Thereafter, the erasing power was applied while the linear velocity was gradually increased. The linear velocity at which an erasability of 25 dB was reached was determined. This linear velocity is a maximum linear velocity at which erasing is possible, and reported in Table 2 as “erasable linear velocity.”

TABLE 2

| | | Erasable linear |
|---|---|---|
| Sample | Auxiliary | velocity |
| No. | component | (m/s) |
| 1 | — | 13 |
| 2 | Ge | 12 |
| 3 | Ge | 11 |
| 4 | Ge | 8 |
| 5 | Tb | 17 |
| 6 | Tb | 25 |

It is evident from Table 2 that the use of Tb as the auxiliary component improves the erasable linear velocity. That is, the addition of Tb as the auxiliary component not only improves the thermal stability, but increases the crystal transition speed of the recording layer. Similar results were obtained when other rare earth elements such as Y, Dy and Gd were used as the auxiliary component.

### BENEFITS OF THE INVENTION

In the phase change optical recording medium according to the invention, microscopic recorded marks which are stabilized in shape and size can be formed. The medium remains reliable in that the microscopic recorded marks are also improved in thermal stability.

Japanese Patent Application No. 2000-185496 is incorporated herein by reference.

Reasonable modifications and variations are possible from the foregoing disclosure without departing from either the spirit or scope of the present invention as defined by the claims.

What is claimed is:

1. An optical recording medium having a phase change recording layer containing antimony as a main component, in which recorded marks having a shortest length of up to 350 nm are formed.

2. The optical recording medium of claim 1 wherein said recording layer further contains tellurium or indium or both as a main component.

3. The optical recording medium of claim 1 wherein said recording layer further contains at least one element selected from the group consisting of germanium, nitrogen and rare earth elements as an auxiliary component.

4. An optical recording method comprising the step of irradiating recording beam which has been power modulated between a high power and a low power, to the optical recording medium of any one of claims 1 to 3 for thereby forming amorphous recorded marks in the recording layer,
said recorded marks including shortest recorded marks having a leading edge and a trailing edge, at least a part of the trailing edge being convex toward the leading edge.

5. The optical recording method of claim 4 wherein the convex shape at the trailing edge of the shortest recorded marks is formed by causing the regions melted by irradiation of recording beam to crystallize.

6. The optical recording method of claim 4 wherein the shortest recorded marks are formed so as to meet the relationship:
M_{L}≦0.4λ/NA
wherein the shortest recorded marks have a length M_{L}, the recording beam has a wavelength λ, and an objective lens of a recording optical system by which the recording beam is transmitted has a numerical aperture NA.

7. The optical recording method of claim 4 wherein the shortest recorded marks are formed so as to meet the relationship:
M_{W}/M_{L}>1
wherein the shortest recorded marks have a width M_{W} and a length M_{L}.
